(19) United States
(12) Patent Application Publication
(10) Pub. No.: US 2010/0243782 A1
(43) Pub. Date: Sep. 30, 2010

(54) BELT RETRACTOR

(75) Inventors: Joachim Biller, Lorch (DE); Nizam Bedak, Schwaebisch Gmuend (DE); Frank Hufschmied, Goeppingen (DE)

Correspondence Address: TAROLLI, SUNDHEIM, COVELL & TUMMINO L.L.P., 1300 EAST NINTH STREET, SUITE 1700, CLEVELAND, OH, 44114, US

(73) Assignee: TRW Automotive GmbH

(21) Appl. No.: 12/729,539

(22) Filed: Mar. 23, 2010

(30) Foreign Application Priority Data
Mar. 26, 2009 (DE) 10 2009 015 000.5

(51) Int. Cl. B60R 22/34; B60R 22/36; B60R 22/46

(52) U.S. Cl. 242/374; 242/379.1

(57) ABSTRACT

A belt retractor (10) comprises a belt reel (12), an adaptive belt limiter (20) and a belt tensioner (22). The force limiter (20) is arranged between the belt reel (12) and the belt tensioner (22) and is operated with a high characteristic during tensioning.

### FIELD OF THE INVENTION

The invention relates to a belt retractor comprising a belt reel, an adaptive force limiter and a belt tensioner.

### BACKGROUND OF THE INVENTION

Belt retractors for a vehicle seat belt include a belt tensioners adapted to tension the seat belt upon a sudden deceleration in order to eliminate a belt slack. The belt tensioners can be coupled to the belt reel and rotate the same so that the belt is wound around the belt reel. In order to avoid an excessive increase in the load acting on the vehicle occupant by the safety belt in the case of vehicle deceleration, moreover force limiters are known to permit a limited belt extension from a defined extending force applied to the belt strap. Force limiters of this type are arranged directly at the belt reel and permit a rotation of the belt reel from a particular torque resulting at the belt reel from the extending force of the belt strap.

In order to prevent the force limiter from deforming by the belt tensioner, deforming elements are known from prior art which are arranged between the belt tensioner and the force limiter and which dampen the load peak of the belt tensioning means by deformation at the beginning of the tensioning operation so that the force limiter is not released or deformed during the tensioning operation. It is a drawback of this arrangement that the effect of the belt tensioner is reduced by the deforming element.

It is the object of the invention to provide a belt retractor comprising an adaptive force limiter and a belt tensioner providing an improved tensioning effect without restricting the force limiter and moreover requiring no additional deforming element.

### SUMMARY OF THE INVENTION

In accordance with the invention, a belt retractor including a belt reel, an adaptive force limiter and a belt tensioner is provided for this purpose. The force limiter is disposed between the belt reel and the belt tensioner and is operated during tensioning with a high characteristic. The high characteristic of the force limiter is preferably selected so that the torque required to activate the force limiter is higher than the torque provided by the belt tensioner. The force limiter thus cannot be deformed by the belt tensioner. Upon releasing the belt tensioner the provided torque is transmitted directly to the belt reel so that in any case first the belt is tensioned before then a force limitation can be effectuated by extension of the belt strap. The function of the belt tensioner and the force limiter is thus ensured without restriction.

Preferably, a coupling is arranged between the belt tensioner and the force limiter so that the belt tensioner is not permanently connected to the force limiter and to the belt reel. For instance, the belt retractor may include a control for controlling the coupling. It is also possible, however, that upon release of the belt tensioning means the coupling automatically couples the latter to the force limiter.

The adaptive force limiter is switchable, for instance, and can be switched from the high characteristic to a lower characteristic when the tensioning operation is completed so that a belt extension is also possible with a lower extending force. In this way, the belt retractor can be adapted, for example, to the weight of a vehicle occupant or the intensity of deceleration. Since the force limiter is operated with the high characteristic during tensioning, an influence of the force limiter by the belt tensioner is still safely excluded.

For example, the force limiter can have two deforming elements known from prior art. In order to obtain a high characteristic, they are arranged functionally in parallel to each other. In order to obtain a lower characteristic, a deforming element can be deactivated so that the force is limited only through a deforming element having a lower resistance. Either of the deforming elements can be a torsion rod or a spring element, for instance.

It is also imaginable that the force limiter includes other force limiting elements known from prior art, for instance a cutting insert.

As an alternative, the use of a force limiter including a highly viscous fluid is possible. Such force limiters have a chamber filled with a medium in which a displacing element such as a rotor is arranged which is moved in the chamber upon rotation of the belt reel and is decelerated by the fluid. Due to the high viscosity of the fluid, such a force limiter exhibits an auto-adaptivity, i.e. the resistance of the force limiter can automatically adapt to the intensity of deceleration. Upon rapid sudden movements caused by an accident, the force limiter offers high resistance due to the high shearing resistance of the fluid so that the force limiter shows a high characteristic. With an increasing duration of the force effect, the resistance is reduced so that the characteristic is falling. On the other hand, in the case of slow movements or small forces the resistance is lower.

It is equally possible to make use of an adaptive force limiter in which the force is limited by means of a cross-linked polymer which is shorn under load. With force limiters of this type also a high tensioning force can be introduced. In this case, too, the force limiter offers high resistance in the event of rapid sudden movements caused by accident so that the force limiter shows a high characteristic. With an increasing duration of the force effect, the resistance is reduced so that the characteristic curve falls. On the other hand, in the case of slow movements or smaller forces the resistance is lower.

Independently of the configuration, a control providing a signal for driving the force limiter can be provided. To this effect, the control can take up various vehicle data, for instance the intensity of deceleration or the impact or specific personal data such as the weight or the size of the vehicle occupant so that the force limiter can be switched to a lower characteristic curve, where necessary.

In accordance with the invention, further a method of tensioning a seat belt is provided. The method includes the following steps:
a belt tensioner is activated while a force limiter shows a high characteristic curve;
upon completion of the tensioning operation the force limiter is switched to a lower characteristic curve, if a corresponding sensor signal is provided.

Preferably the force limiter is switched to a lower characteristic immediately after completion of the tensioning operation, if the sensor signal is provided so that immediately after completion of the tensioning operation the force can be limited, whereby the risk of injury by the belt can be minimized for a vehicle occupant.

### BRIEF DESCRIPTION OF THE DRAWINGS

FIG. 1 shows a schematic representation of a belt retractor according to the invention, and

FIG. 2 shows the characteristic curve of the belt retractor of FIG. 1.

### DESCRIPTION OF THE EXAMPLE EMBODIMENT

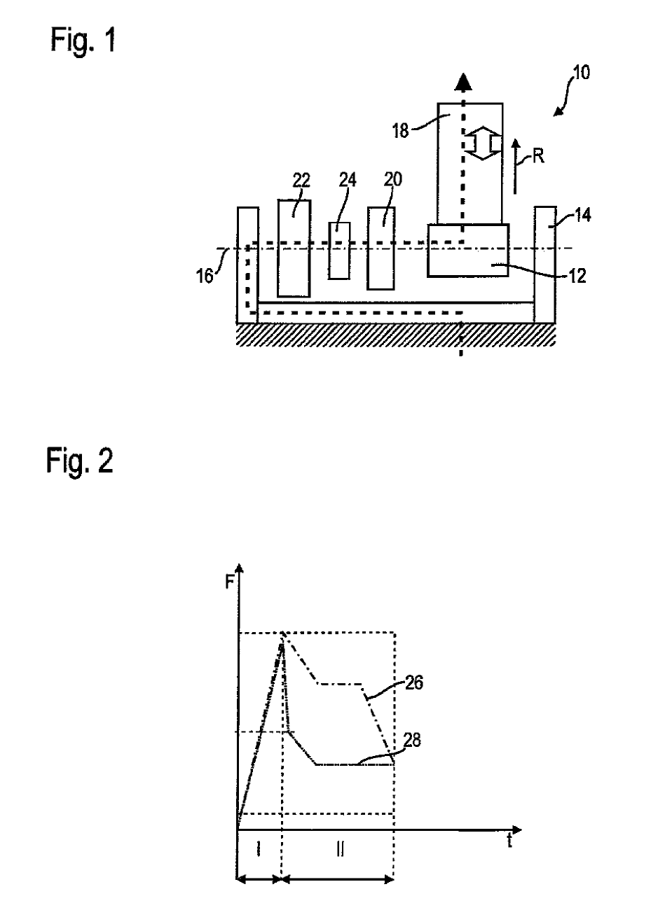

In FIG. 1 the schematic structure of a belt retractor 10 is illustrated. The belt retractor 10 includes a belt reel 12 which is rotatably supported in a frame 14 about an axis of rotation 16 and around which a belt strap 18 of a seat belt is wound. The belt retractor 10 further includes an adaptive or switchable force limiter 20 arranged directly at the belt reel 12 and a belt tensioner 22. The belt tensioner 22 can be coupled to the force limiter 20 by a coupling 24.

In the case of a major deceleration, for instance in the case of accident, the coupling 24 can connect the belt tensioner 22 to the force limiter 20 and thus to the belt reel 12. The belt tensioner 22 is adapted to rotate the belt reel 12 so that the belt strap 18 is wound around the belt reel 12. The belt strap 18 is tensioned so that a belt slack is eliminated. The vehicle occupant is thus caught by the seat belt at an earlier point in time and can earlier join the total deceleration of the vehicle.

The tensioning force is transmitted, however, via the force limiter 20 to the belt reel 12. In this way the tensioning force could deform or activate the force limiter 20 so that no sufficient tensioning effect could be achieved at the belt reel 12 or the belt strap 18. In order to prevent the force limiter 20 from being released by the belt tensioner 22, hitherto additional deforming elements adapted to resiliently cushion the load peaks at the beginning of the tensioning operation have been disposed between the force limiter 20 and the belt tensioner 22.

In accordance with the invention, the force limiter 20 is operated during tensioning with a characteristic which is sufficiently high to prevent release by the tensioning force of the belt tensioner 22. In this case, the force limiter 20 is a switchable force limiter which can be changed to a lower characteristic after completion of the tensioning operation.

Switch-over to a lower characteristic curve is performed by a control. Such control can be switched dependent on time or dependent on sensors taking up vehicle occupant-specific or vehicle-specific data, for instance.

The diagram shown in FIG. 2 illustrates the course of time of the retaining force F over the time t of the retaining operation. The upper curve 26 represents the force path with a high characteristic of the force limiter 20, the lower curve 28 shows the force path when the force limiter 20 is switched to a lower characteristic upon completion of the tensioning operation.

Directly at the beginning of the retaining operation, the belt tensioner 22 is activated and applies a tensioning force directed against the extending direction R to the belt reel 12 and thus to the belt strap 18. The tensile force F acting on the belt strap 18 is therefore strongly increased in a period I directly after blocking the belt tensioner 22. Upon completion of the tensioning operation, during a period II the force limiter 20 permits a defined belt extension resulting in a decrease of the force F acting on the belt. When the force limiter 20 is not switched over, i.e. in the case of the upper characteristic 26, the force acting on the belt strap 18 is reduced only slowly, because the belt strap can only be extended against high resistance. Thus this setting is suited for a heavy-weight vehicle occupant or for a strong deceleration of the vehicle. If, however, the force limiter 20 is switched to the lower characteristic 28 immediately after tensioning, the force F required for the extension of the belt strap 18 is definitely lower so that the belt strap can be extended even with a lower extending force.

Any adaptive force limiter can be employed as force limiter 20 in this case. For instance, the force limiter can include a deforming element, for example a torsion rod, or a combination of different deforming elements.

### Also

As an alternative, it is possible to use a force limiter 20 including a viscous fluid having an auto-adaptivity so that a control of the force limiter 20 can be dispensed with, where appropriate. Such viscous force limiter exhibits a resistance element that is moved in a viscous fluid. By virtue of the viscosity of the fluid, the resistance of the force limiter 20 increases in the case of rapid sudden movements. When the belt tensioner 22 is activated and, as a consequence, suddenly force is introduced to the force limiter 20, the resistance of the force limiter 20 is increased so that the tensioning force can be directly transmitted to the belt reel 12.

A control of the force limiter can also be dispensed with, when an adaptive force limiter is used in which the force is limited by means of a cross-linked polymer shorn under load. In the case of force limiters of this type also a high tensioning force can be introduced. In the event of rapid sudden movements such a force limiter exhibits a high resistance so that the force limiter shows a high characteristic. Thus the tensioning force can be directly transmitted to the belt reel.

1. A belt retractor (10) comprising a belt reel (12), an adaptive force limiter (20) and a belt tensioner (22), characterized in that the force limiter (20) is disposed between the belt reel (12) and the belt tensioner (22) and that during a tensioning operation the force limiter (20) is operated with a high characteristic (26).

2. A belt retractor according to claim 1, characterized in that a coupling (24) is disposed between the belt tensioner (22) and the force limiter (20).

3. A belt retractor according to claim 1, characterized in that the force limiter (20) is switchable and, after completion of a tensioning operation, can be changed from the high characteristic (26) to a lower characteristic (28).

4. A belt retractor according to claim 3, characterized in that the force limiter (20) has a deforming element, especially a torsion rod.

5. A belt retractor according to claim 3, characterized in that the force limiter (20) has a cutting insert.

6. A belt retractor according to claim 1, characterized in that the force limiter (20) includes a viscous fluid.

7. A belt retractor according to claim 1, characterized in that the force limiter includes a cross-linked elastomer which is shorn under load.

8. A belt retractor according to claim 1, characterized in that a control is provided which produces a signal for controlling the force limiter (20).

9. A method of tensioning a seat belt by means of the following steps:
a belt tensioning means (22) is activated while a force limiter (20) is at a high characteristic (26);
after completion of the tensioning operation the force limiter (20) is switched to a lower characteristic (28) if an appropriate sensor signal is provided.

10. A method according to claim 8, characterized in that, if the sensor signal is provided, the force limiter (20) is switched to a lower characteristic (28) immediately after completion of the tensioning operation.
